(19) United States
(12) Patent Application Publication
(10) Pub. No.: US 2026/0078693 A1
(43) Pub. Date: Mar. 19, 2026

(54) METHODS AND SYSTEM FOR OPERATING AN INTAKE AIR COMPRESSOR AND A CHARGE-AIR COOLER AS HEAT SOURCES IN HYBRID VEHICLES

(71) Applicant: Ford Global Technologies, LLC, Dearborn, MI (US)

(72) Inventors: Hans Guenter Quix, Herzogenrath (DE); Julio Orozco Santos Coy, Aachen (DE); Dennis Hesse, Cologne (DE); Jan Mehring, Koeln (DE); Rolf Lorenz Loeffler, Rommerskirchen (DE)

(21) Appl. No.: 19/327,967

(22) Filed: Sep. 12, 2025

(30) Foreign Application Priority Data
Sep. 16, 2024 (DE) 102024126546.9

(51) Int. Cl. F01P 3/20; B60H 1/03; B60L 58/26; F01P 3/18; F01P 5/10; F01P 7/14; F02B 39/00; F02B 39/10

(52) U.S. Cl. CPC F01P 3/20; B60H 1/034; B60L 58/26; F01P 3/18; F01P 5/10; F01P 7/14; F02B 39/005; F02B 39/10; F01P 2007/146; F01P 2060/08; F01P 2060/12

(57) ABSTRACT

Methods and systems are provided for a thermal management system. In one example, a thermal management system for a vehicle comprising an internal combustion engine comprising an intake tract and an exhaust tract, the vehicle further comprising at least one electric motor driven by a battery, the thermal management system including a first coolant circuit coupled to each of the internal combustion engine, an electric compressor, an electric charge-air compressor arranged in the intake tract, an interior compartment heating device, and a high-temperature radiator, a second coolant circuit coupled to each of a charge-air cooler arranged in the intake tract and a low-temperature radiator, a third coolant circuit coupled to each of the battery and at least one indirect condenser.

### CROSS REFERENCE TO RELATED APPLICATION

The present application claims priority to German Patent Application No. 102024126546.9 filed on Sep. 16, 2024. The entire contents of the above-listed application is hereby incorporated by reference for all purposes.

### FIELD

The present description relates generally to a thermal management system for a hybrid vehicle, in which an electric charge-air compressor is used as a heat source for the vehicle, to a vehicle having the thermal management system, and to a method for controlling temperatures of devices of the vehicle.

### BACKGROUND/SUMMARY

In hybrid vehicles, at least two drive units are combined with one another. The at least two drive units are an internal combustion engine and an electric motor. This may result in a complex drive system, which has firstly an internal combustion engine having a transmission and secondly an electrically operated drive system. To provide desired operating temperatures, a thermal management system may include a high-temperature circuit is provided for the internal combustion engine and a low-temperature circuit is provided for a charge-air cooler and, if demanded, for a drive battery and/or the electric motor (as described for example in the document DE 10 2005 047 653 A1).

Electric compressors may be used to compress charge air for the internal combustion engine. An electric compressor may be used on its own or in combination with a compressor of a turbocharger to increase the power of the vehicle, optimize fuel consumption, and reduce exhaust-gas emissions. Here, the electric compressor is driven by an electric motor, which increase a rotational speed of the electric compressor to a high rotational speed.

For electric driving operation, hybrid vehicles typically have at least one PTC (positive temperature coefficient) heating element as a heating device for heating, for example, a drive battery and the vehicle interior compartment, because exhaust-gas heat from the internal combustion engine is not available during an electric only drive mode.

A PTC heating element increases a packaging space and thus contributes to the complexity of the drive system in a hybrid vehicle. Furthermore, the PTC heating element may effect energy consumption due to its weight and increases manufacturing costs. Thus, it may be desired to eliminate the inclusion of the PTC heating element.

In one example, the issues described above may be at least partially solved by a thermal management system for a vehicle comprising an internal combustion engine comprising an intake tract and an exhaust tract, the vehicle further comprising at least one electric motor driven by a battery, the thermal management system including a first coolant circuit coupled to each of the internal combustion engine, an electric compressor, an electric charge-air compressor arranged in the intake tract, an interior compartment heating device, and a high-temperature radiator, a second coolant circuit coupled to each of a charge-air cooler arranged in the intake tract and a low-temperature radiator, a third coolant circuit coupled to each of the battery and at least one indirect condenser, a controller with instructions stored in non-transitory memory thereof that when executed cause the controller to adjust a position of pumps and valves arranged in the first coolant circuit, the second coolant circuit, and the third coolant circuit to direct a flow of coolant heated by an electric compressor to one or more of the internal combustion engine, the interior compartment heating device, and the battery when the engine is off.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of a thermal management system according to the prior art

FIG. 2 is a schematic diagram of a thermal management system according to an embodiment of the disclosure.

FIG. 3 is the schematic diagram as per FIG. 2 in a mode in which the internal combustion engine is running.

FIG. 4 is the schematic diagram as per FIG. 2 in a mode, in which the internal combustion engine has been shut down, for heating the vehicle interior compartment.

FIG. 5 is the schematic diagram as per FIG. 2 in a mode, in which the internal combustion engine has been shut down, for heating the vehicle interior compartment and a battery

FIG. 6 is the schematic diagram as per FIG. 2 in a mode, in which the internal combustion engine has been shut down, for heating the vehicle interior compartment, the battery and the internal combustion engine.

FIG. 7 is the schematic diagram as per FIG. 2 in a mode, in which the internal combustion engine has been shut down, for heating the vehicle interior compartment, the battery and the internal combustion engine, with air being supplied to the internal combustion engine.

FIG. 8 is the schematic diagram as per FIG. 2 in a mode, in which the internal combustion engine has been shut down, for heating the vehicle interior compartment and the internal combustion engine.

FIG. 9 is the schematic diagram as per FIG. 2 in a mode, in which the internal combustion engine has been shut down, for heating the vehicle interior compartment and the internal combustion engine, with air being supplied to the internal combustion engine.

FIG. 10 is a flow diagram of an embodiment of a method according to the disclosure.

FIG. 11 is a method for selecting a heating mode based on temperatures of the vehicle cabin.

### DETAILED DESCRIPTION

The following description relates to systems and methods for a thermal management system that utilizes heat generated by an electric compressor. A first aspect of the disclosure relates to a thermal management system for a vehicle which comprises an internal combustion engine having an intake tract and an exhaust tract and comprises at least one electric motor driven by a battery. The thermal management system includes a first coolant circuit, which is configured as a high-temperature circuit and flows coolant through the internal combustion engine, through an electric charge-air compressor arranged in the intake tract, through an interior compartment heating device and through a high-temperature radiator. The thermal management system further includes a second coolant circuit, which is configured as a low-temperature circuit that flows coolant through a charge-air cooler arranged in the intake tract and through a low-temperature radiator. The thermal management system further includes a third coolant circuit, which is configured as a battery cooling circuit that flows coolant through the battery and through at least one indirect evaporator. The thermal management system further includes a control device, wherein a number of pumps and controllable valves are provided for driving and controlling the liquid flow in the circuits. The high-temperature circuit may be connected at in each case at least two points to the low-temperature circuit and to the battery cooling circuit, wherein the connections may be made reversibly by adjustment of control valves, and thus parts of the second and third coolant circuit may be combined with the first coolant circuit.

The disclosure utilizes the thermal energy that is produced by the electric compressor arranged in the intake tract. In other words, the electric compressor is used as a heating element. It is thus possible to dispense with (e.g., not include) a PTC element as a heating device, and to thus save costs, space, and weight in the vehicle. Here, the charge-air cooler may be connected to the high-temperature circuit to utilize the heat that is produced by the electric compressor. Furthermore, the heat may be used not only for heating the battery and the vehicle interior compartment but also for heating the internal combustion engine prior to a planned start of the engine. It is thus possible to reduce emissions of the internal combustion engine, which are higher in the case of a cold start than in the case of a hot start. The disclosure is accordingly also ecologically beneficial, in particular in order to comply with the exhaust-gas regulations specified by law.

The terms “drive battery” and “battery” are used synonymously, i.e., where a battery is referred to, this means the drive battery.

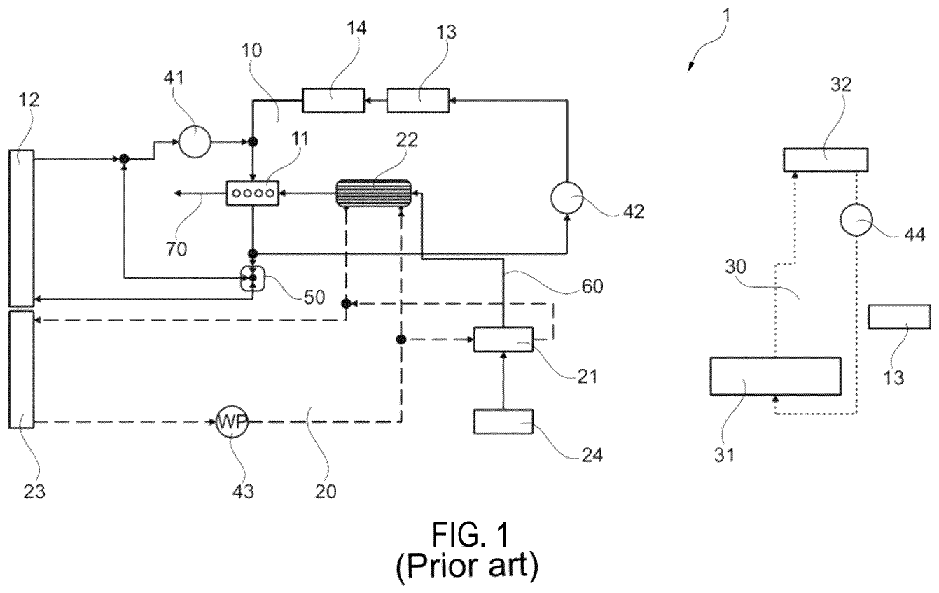

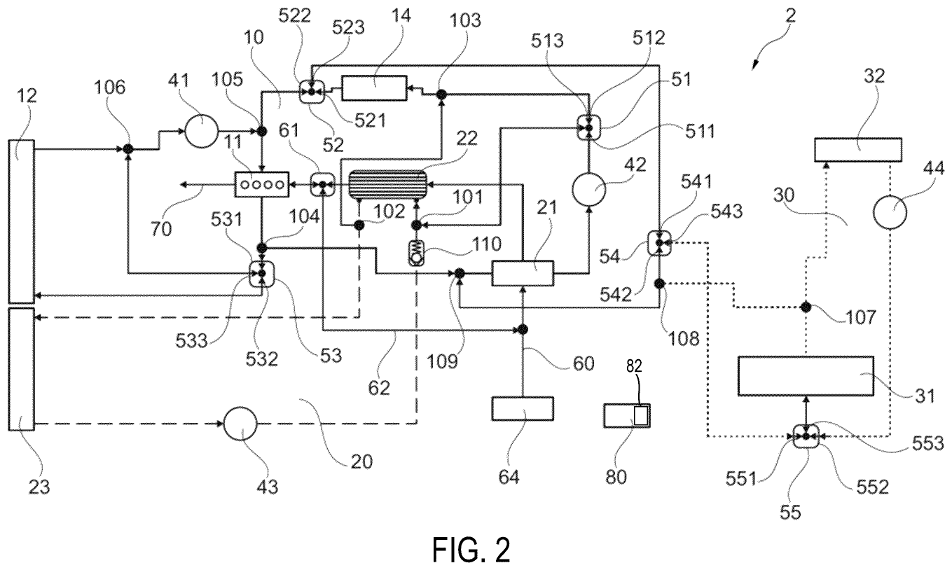

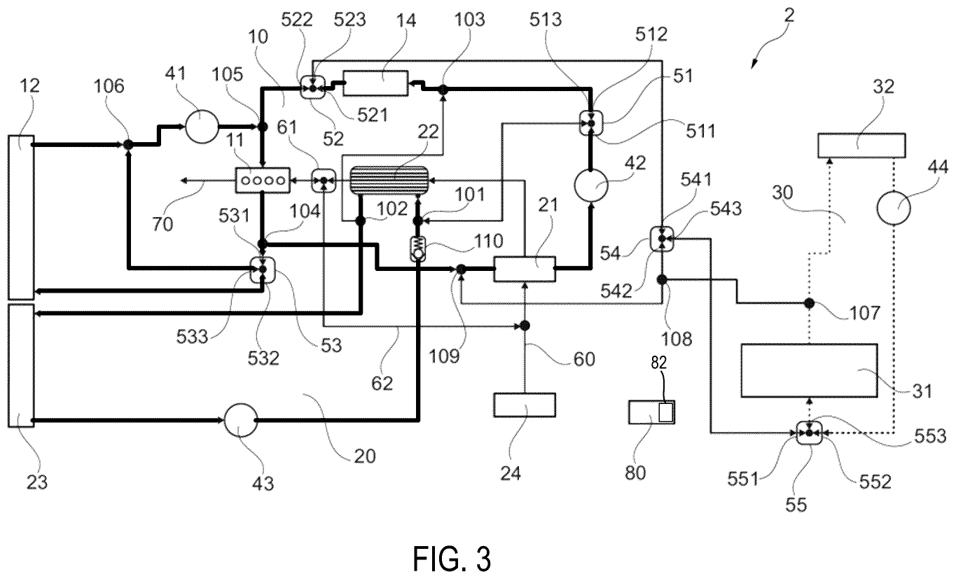

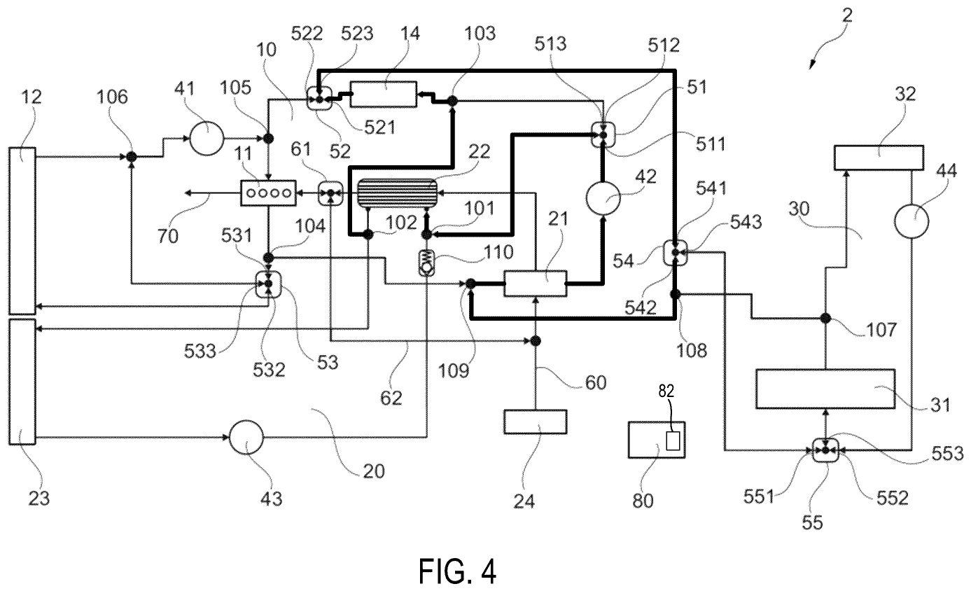

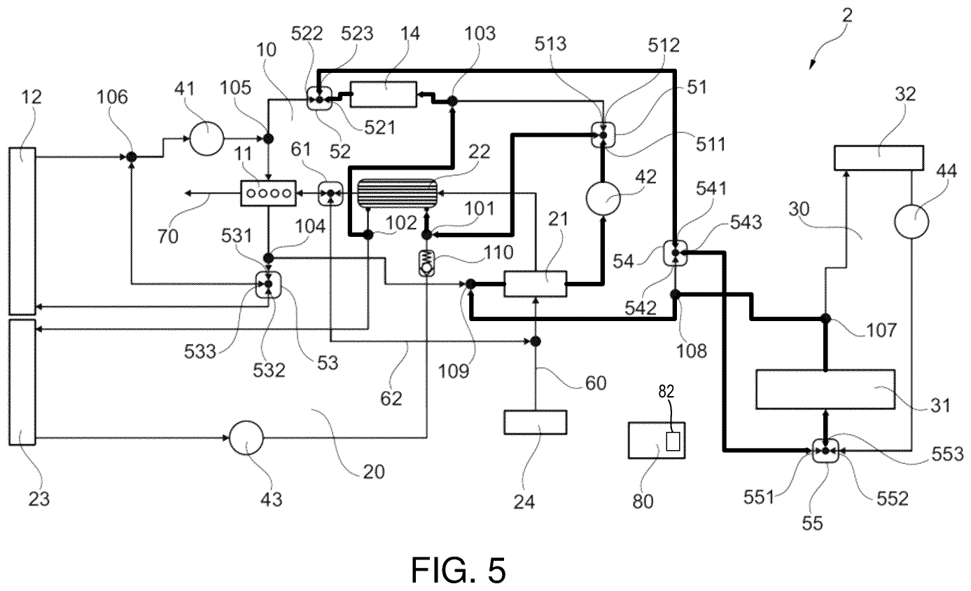

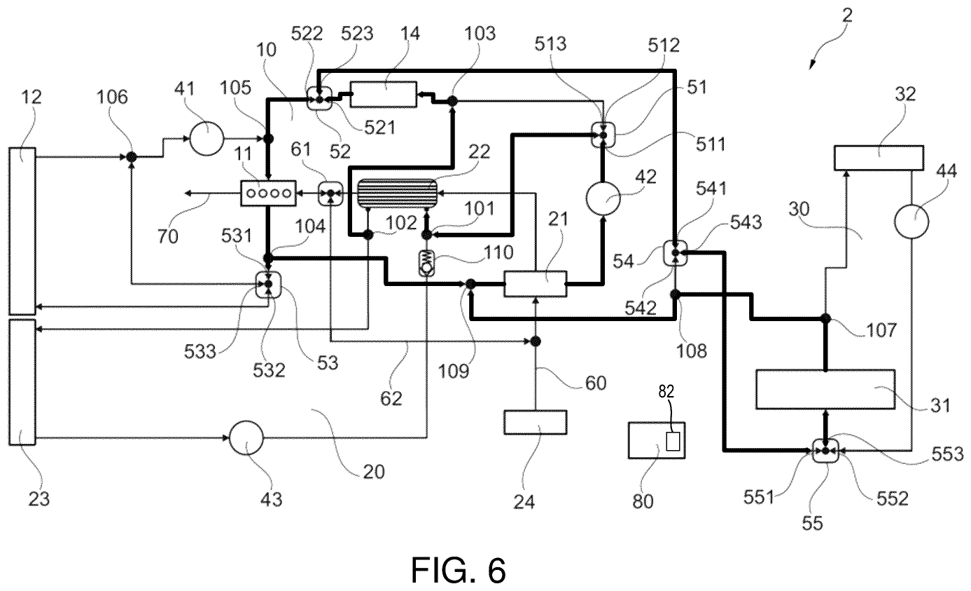

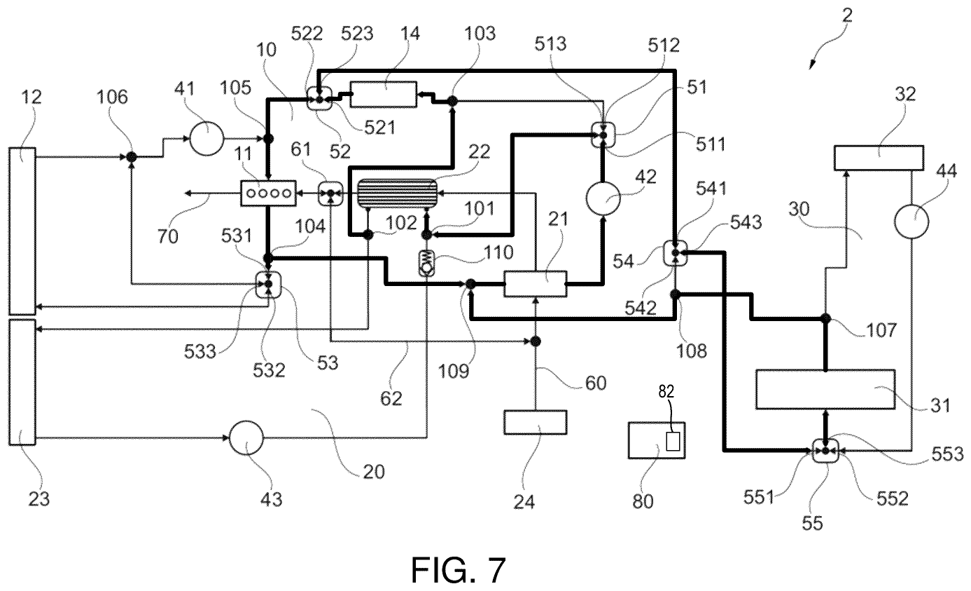

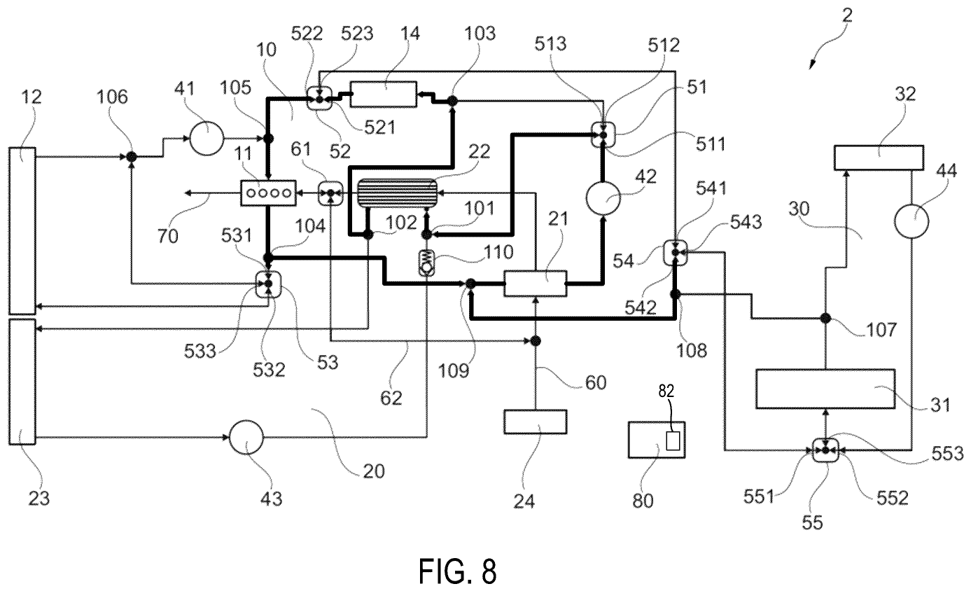

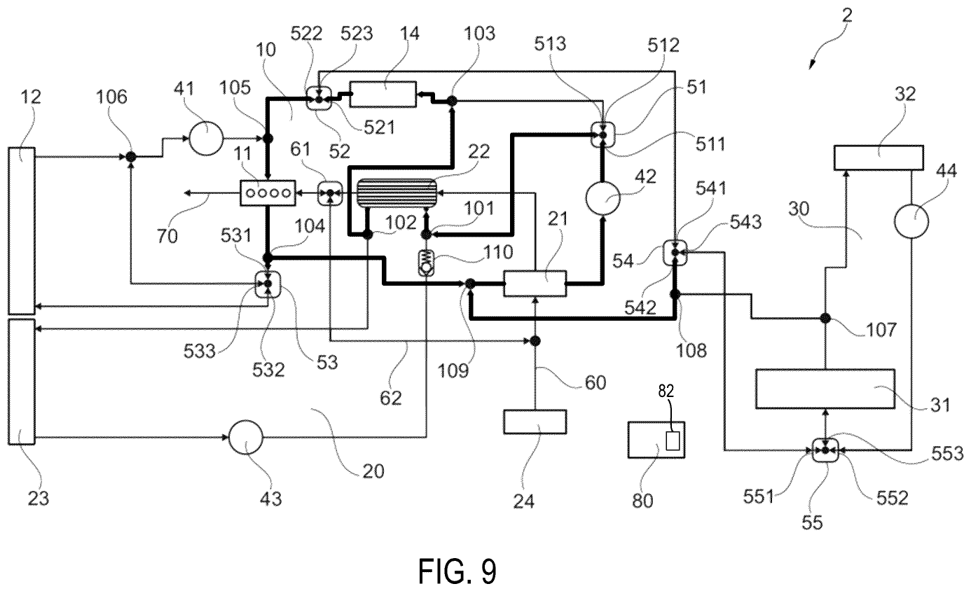

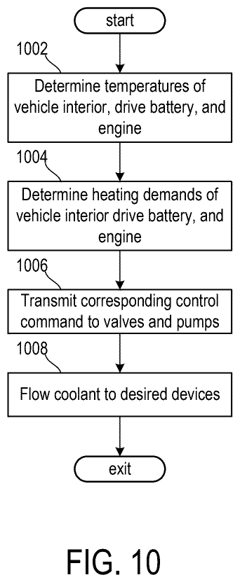

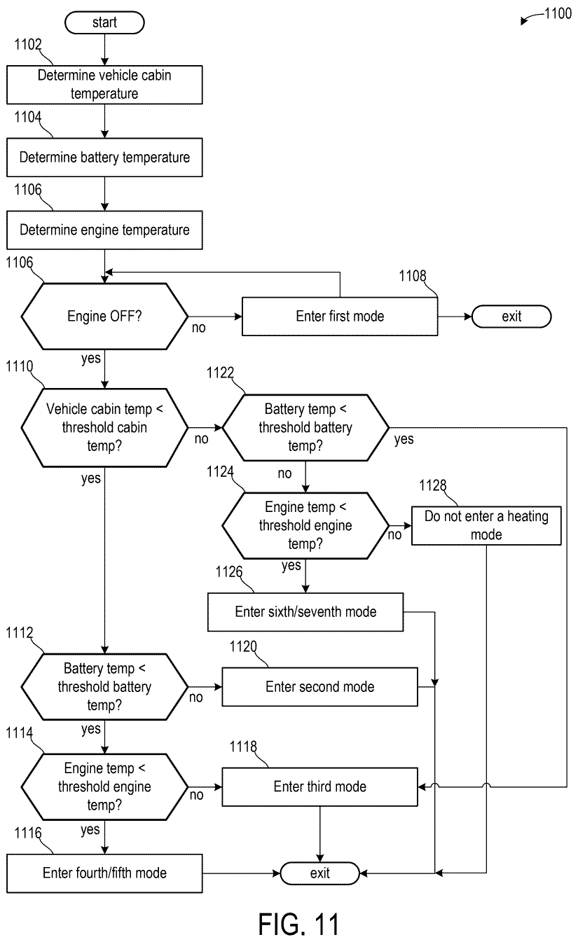

FIG. 1 is a schematic diagram of a thermal management system according to the prior art. FIG. 2 is a schematic diagram of a thermal management system according to an embodiment of the disclosure. FIG. 3 is the schematic diagram as per FIG. 2 in a mode in which the internal combustion engine is running. FIG. 4 is the schematic diagram as per FIG. 2 in a mode, in which the internal combustion engine has been shut down, for heating the vehicle interior compartment. FIG. 5 is the schematic diagram as per FIG. 2 in a mode, in which the internal combustion engine has been shut down, for heating the vehicle interior compartment and a battery. FIG. 6 is the schematic diagram as per FIG. 2 in a mode, in which the internal combustion engine has been shut down, for heating the vehicle interior compartment, the battery and the internal combustion engine. FIG. 7 is the schematic diagram as per FIG. 2 in a mode, in which the internal combustion engine has been shut down, for heating the vehicle interior compartment, the battery and the internal combustion engine, with air being supplied to the internal combustion engine. FIG. 8 is the schematic diagram as per FIG. 2 in a mode, in which the internal combustion engine has been shut down, for heating the vehicle interior compartment and the internal combustion engine. FIG. 9 is the schematic diagram as per FIG. 2 in a mode, in which the internal combustion engine has been shut down, for heating the vehicle interior compartment and the internal combustion engine, with air being supplied to the internal combustion engine. FIG. 10 is a flow diagram of an embodiment of a method according to the disclosure. FIG. 11 is a method for selecting a heating mode based on temperatures of the vehicle cabin.

In one example, additionally or alternatively, a bypass valve is arranged in the intake tract downstream of the charge-air cooler, at which a bypass line branches off the bypass valve, which opens into the intake tract upstream of the electric compressor. The bypass line allows a circulation of air through the housing of the electric compressor and the charge-air cooler when the internal combustion engine is not running. In this way, both the heat that may be dissipated at the compressor housing, and the heat that is present in the air stream, may be utilized by means of the charge-air cooler.

In one example, additionally or alternatively, at least one first control valve is arranged downstream of the electric compressor in a flow path of the first coolant circuit between the electric compressor and the interior compartment heating device. This arrangement allows the coolant flow to be directed from the electric compressor directly to the interior compartment heating device, in particular when the internal combustion engine is running, in order to be able to directly utilize the heat of said internal combustion engine for heating the interior compartment. Furthermore, this arrangement allows the coolant flow to be directed to the charge-air cooler in order that, when the internal combustion engine is in a shut-down state (e.g., not combusting fuel), the heat, present in the air stream, of the electric compressor may also be utilized via the charge-air cooler.

In one example, additionally or alternatively, a second control valve may be arranged downstream of the interior compartment heating device in a flow path of the first coolant circuit between the interior compartment heating device and the internal combustion engine. The arrangement may allow the coolant flow to be directed into a circuit directly to the electric compressor in order that, when the internal combustion engine is in a shut-down state, if there is only a demand for heating the interior compartment, this demand may be expediently met without dissipating heat to other devices and corresponding pipework. It is also thus possible to divert the coolant flow in the direction of the third coolant circuit. By means of the second control valve, the coolant flow may alternatively also be directed from the interior compartment heating device to the internal combustion engine, such that it is also possible for heated coolant to be provided for the purposes of heating the internal combustion engine when this is to be set in operation. Furthermore, the coolant flow may also be split at the second control valve such that, downstream of the interior compartment heating device, coolant may be directed both to the internal combustion engine and to the battery.

In one example, additionally or alternatively, a third control valve is arranged downstream of the internal combustion engine in a flow path of the first coolant circuit between the internal combustion engine and the high-temperature cooling device. This arrangement is configured for coolant to be directed from the internal combustion engine via the high-temperature radiator and for said internal combustion engine to thus be cooled when it is in operation, or for the coolant to be directed via the compressor in order to use heat of the electric compressor to heat the internal combustion engine when it is not in operation but is to be set in operation imminently.

In one example, additionally or alternatively, a fourth control valve, at which the third coolant circuit branches off, is arranged downstream of the second control valve in a flow path of the first coolant circuit between the second control valve and the electric compressor. This arrangement is configured to provide a connection of the first coolant circuit to the third coolant circuit to be able to supply heat to the battery in order that it reaches its operating temperature.

In one example, additionally or alternatively, a fifth control valve is arranged upstream of the battery in a flow path of the third coolant circuit between the fourth control valve and the battery. This arrangement is configured for the coolant flow to be directed to the battery and from there back to the first coolant circuit, without heated coolant flowing through the indirect evaporator of the third coolant circuit, in order to be able to supply heat to the battery in order that it reaches its operating temperature.

A third aspect of the disclosure relates to a method for heating devices of a motor vehicle via the thermal management system. Operation of the thermal management system may be adjusted depending on respective temperature requirements of the internal combustion engine, of the vehicle interior compartment, and/or of the battery. The control valves of the thermal management system are adjusted such that, with the internal combustion engine shut down, at least one flow of coolant from the electric compressor to the interior compartment heating device is provided. The method may further include determining the temperatures in devices of the vehicle comprising the vehicle interior compartment, the battery, and the internal combustion engine via respective temperature sensors. The method may further include determining, via the control device (e.g., a controller or a processor), the demands for heating said devices of the vehicle, wherein it becomes desired for heated coolant to be directed to the devices if a threshold value of the temperature of a corresponding device is not reached. The method may further include transmitting a control command from the control device to respective actuators of the control valves and pumps, switching positions and/or operation of the control valves and pumps such that a flow of coolant is directed to said devices in accordance with demands.

In one example, additionally or alternatively, in the method, at least one flow from the interior compartment heating device to the battery is additionally provided. This allows not only the heating of the interior compartment but also heating of the battery upon a start of operation.

In one example, additionally or alternatively, at least one flow from the interior compartment heating device to the internal combustion engine is additionally provided. This allows heating of the internal combustion engine prior to a start of operation, which has a favorable effect on the emissions of the internal combustion engine, because a cold internal combustion engine produces more emissions upon starting than a hot internal combustion engine. Coolant may be directed to the internal combustion engine alternatively or additionally to the battery.

In one example, additionally or alternatively, when the internal combustion engine is not running, the bypass valve is switched such that the intake air is recirculated through the electric compressor and/or flows through the internal combustion engine. It is thus possible to utilize the heat which is dissipated at the compressor housing and the heat which, via the charge-air cooler, is present in the air stream.

Turning now to FIG. 1, it shows a thermal management system 1 according to the prior art, for controlling temperatures in the drive system of a hybrid vehicle has a first coolant circuit 10, configured as a high-temperature circuit, has a second coolant circuit 20, designed as a low-temperature circuit, and has a battery coolant circuit 30. In the system 1, said coolant circuits 10, 20, 30 are not interconnected. That is to say, coolant circuits 10, 20, and 30 are fluidly sealed from one another such that coolant does not flow therebetween.

In the first coolant circuit 10, flow passes through an internal combustion engine 11, through a high-temperature radiator 12, through a PTC element 13, and through an interior compartment heating device 14. In the first coolant circuit 10, for the purposes of driving a flow of the coolant, a first pump 41 is arranged in a flow path upstream of the internal combustion engine 11, and a second pump 42 is arranged downstream of the internal combustion engine 11 in a flow path between the internal combustion engine 11 and PTC element 13. The first coolant circuit 10 branches downstream of the internal combustion engine 11 into said flow path to the PTC element 13 and a flow path in the direction of the high-temperature radiator 12. A temperature-dependent control valve 50 is arranged downstream of said branching point. The control valve 50 is connected to a flow path to the high-temperature radiator 12 and to a direct circuit back to the internal combustion engine 11, and said flow path and circuit may be activated alternatively on a temperature-dependent basis. The first coolant circuit 10 is illustrated using solid lines.

In a second coolant circuit 20, flow passes through an electric compressor 21, through a charge-air cooler 22, and through a low-temperature radiator 23. For the purposes of driving a flow of the coolant, a third pump 43 is arranged downstream of the low-temperature radiator 23. The second coolant circuit 20 branches off downstream of the third pump, such that flow may pass through the electric compressor 21 and the charge-air cooler 22 in parallel. The lines converge again downstream of the electric compressor 21 and the charge-air cooler 22, such that one line leads to the low-temperature radiator 23. The second coolant circuit 20 is illustrated using dashed lines. In one example, the low-temperature radiator 23 is a second radiator.

The electric compressor 21 and the charge-air cooler 22 are arranged in an intake tract 60 of the internal combustion engine 11. The electric compressor 21 is provided for compressing charge air for the internal combustion engine 11, and the charge-air cooler 22 is provided for cooling the charge air. An air filter 24 is arranged in the intake tract 60 upstream of the electric compressor 21. An exhaust tract 70 is connected to the internal combustion engine 11 for the purposes of discharging exhaust gas.

In the third coolant circuit 30, flow passes through a drive battery 31 of an electric motor. In the third coolant circuit 32, an indirect condenser, also referred to as a chiller, is cooled for the purposes of cooling the coolant. Here, the flow of the coolant is driven by a fourth pump 44. The third coolant circuit 30 has no connection to the first coolant circuit 10. A further PTC element 13 is provided in the region of the battery 31 for the purposes of heating the battery upon a start of operation. The third coolant circuit 30 is illustrated using dotted lines. The terms “drive battery” and “battery” are used synonymously, i.e., where a battery is referred to, this means the drive battery.

Turning now to FIG. 2, it shows a schematic diagram of an embodiment of a thermal management system 2 according to the disclosure. By contrast to FIG. 1, the three coolant circuits are in this case interconnected. Control valves are arranged in the first coolant circuit 10 and in the third coolant circuit 30 and configured to direct the coolant flow. The control valves will be described below as having inlets and outlets. It is clear that, depending on a flow direction, the inlets of the control valves may also serve as outlets, and vice versa. In one example, the first coolant circuit 10 is a high temperature circuit and the third coolant circuit 30 is a battery coolant circuit.

A first control valve 51 is arranged in the first coolant circuit 10 downstream of the second pump 42. Herein, upstream and downstream are used to describe a relative position of components with respect to fluid flow. A first component upstream of a second component includes where the first component receives fluid prior to the second component. Thus, the second component, which is downstream of the first component, receives fluid after the first component.

The first control valve 51 has an inlet 511, a first outlet 512 and a second outlet 513. An interior compartment heating line to the interior compartment heating device 14 is connected to the first outlet 512. In one example, the interior compartment heating device 14 is a cabin heater. A second outlet line to the second coolant circuit 20 is connected to the second outlet 513, wherein the second outlet line opens into the second coolant circuit 20 at a first connection point 101 upstream of the charge-air cooler 22. In one example, the charge-air cooler 22 is an intercooler. A line of the first coolant circuit 10 branches off from the second coolant circuit 20 again at a second connection point 102 downstream of the charge-air cooler 22, said line opening, at a third connection point 103, into the interior compartment heating line between the first outlet 512 and the interior compartment heating device 14. In one example, the second coolant circuit 20 is a low temperature coolant circuit.

A second control valve 52 is arranged downstream of the interior compartment heating device 14. The second control valve 52 has an inlet 521, a first outlet 522, and a second outlet 523. A second circuit engine line is connected to the first outlet 522 and directs fluid from the second coolant circuit 20 to the internal combustion engine 11. A line to a fourth control valve 54 is connected to the second outlet 523.

A line leads from the internal combustion engine 11 to a third control valve 53. A line to the electric compressor 21 branches off at a fourth connection point 104 upstream of the third control valve 53. The third control valve 53 includes an inlet 531, a first outlet 532, and a second outlet 533. A line to the high-temperature radiator 12 is connected to the first outlet 532. In one example, the high-temperature radiator 12 is a first radiator. A line in which the first heat pump 41 is arranged leads from the high-temperature radiator 12 back to the internal combustion engine 11, said line opening, at a fifth connection point 105 upstream of the internal combustion engine 11, into the line between the second control valve 52 and the internal combustion engine 11. Connected to the second outlet 533 is a line which opens, at a sixth connection point 106 upstream of the first pump 41, into the line between the high-temperature radiator 12 and the first pump 41. The third control valve 53 corresponds to the control valve 50 in FIG. 1, and is accordingly also configured as a thermostat, such that the outlets 532 and 533 may be activated alternatively on a temperature-dependent basis.

The fourth control valve 54 includes an inlet 541, a first outlet 542, and a second inlet 543. Connected to the first outlet 542 is a line which leads to the electric compressor, wherein said line opens, at a sixth connection point 106, into the lines between the internal combustion engine 11 and the electric compressor 21. Via the second outlet 543, the fourth control valve 54 provides a connection to the third coolant circuit 30. A line leads to the second outlet 543 to a fifth control valve 55.

The fifth control valve 55 has a first inlet 551, a second inlet 552 and an outlet 553. The line from the fourth control valve 54 is connected to the first inlet 551. A line to the drive battery 31 is connected to the outlet 553. Downstream of the drive battery 31, at a seventh connection point 107, a line branches off to the first coolant circuit 10, said line opening into the first coolant circuit at an eighth connection point 108 downstream of the fourth control valve 54. At the seventh connection point 107, a further line branches off to the indirect condenser 32. A line leads from the indirect condenser 32 to the second inlet 552 of the fifth control valve 55. A fourth pump 44 is arranged in the line downstream of the indirect condenser 32 and upstream of the fifth control valve 55.

As described above, the second coolant circuit 20 is connected via the connection points 101 and 102 to the first coolant circuit 10. Downstream of the second connection point 102, the line leads from the charge-air cooler 22 to the low-temperature radiator 23. A line in which a third pump 43 is arranged leads from the low-temperature radiator 23 to the charge-air cooler 22. A check valve 110 is arranged in the line downstream of the third pump 43 and upstream of the first connection point 101.

A bypass valve 61 is arranged in the intake tract 60 downstream of the charge-air cooler 22. A bypass line 62 branches off from the intake tract 60 at the bypass valve 61 and opens into the intake tract 60 upstream of the electric compressor 21.

A control device 80 is connected, inter alia, to temperature sensors which are arranged in particular in the region of the internal combustion engine 11, of the interior compartment heating device 14 and of the drive battery 31. Furthermore, the control device is connected inter alia to the control valves 51, 52, 53, 54, 55 and to the pumps 41, 42, 43, 44 in order to control the flow in the thermal management system. In one example, the control device 80 is a controller or a processor with memory 82. In one example, memory 82 is non-transitory memory with instructions stored thereon that when executed cause the controller adjust positions of one or more of the controls valves 51-55 and pumps 41-44

Turning now to FIG. 3, it shows a schematic diagram of the embodiment of FIG. 2 operating in an engine combusting mode (e.g., a first mode). The first mode may include where the internal combustion engine 11 is in operation, which includes where the internal combustion engine is receiving fuel and air and combusting a mixture thereof. The first control valve 51 may be actuated to open up a passage from the inlet 511 to the first outlet 512, such that coolant flows from the second pump 42 to the interior compartment heating device 14. The second control valve 52 may be actuated to open up a passage from the inlet 521 to the first outlet 522, such that coolant flows from the interior compartment heating device 14 to the internal combustion engine 11. The coolant absorbs thermal energy at the internal combustion engine 11. Downstream of the internal combustion engine 11, a proportion of the coolant flows via the fourth connection point 104 to the electric compressor 21, and from there to the second pump 42.

Downstream of the fourth connection point 104, the third control valve 53 may be actuated to open up a passage from the first inlet 531 to the first outlet 532 and to the second outlet 533. Consequently, a proportion of the coolant flows to the high-temperature radiator 12 and a proportion of the coolant flows back to the first pump 41, which drives a flow of the coolant back to the internal combustion engine. Here, the outlets of the third control valve 53, which is configured as a thermostat, are opened on a temperature-dependent basis. Coolant flow in the first mode and the subsequent modes described below is indicated via thicker lines. Coolant lines illustrated via thinner lines may not receive coolant during the first mode and in the subsequent modes described below.

In the first mode shown in FIG. 3, the second coolant circuit 20 is switched to have no connection to the first coolant circuit 10, for the purposes of cooling the charge-air cooler 22. Here, the flow of the coolant from the low-temperature radiator 23 is driven by the third pump 43 and flows through the check valve 110 to the charge-air cooler 22 and from there back to the low-temperature radiator 23. As such, the second coolant circuit 20 is sealed from the first coolant circuit 10 during the first mode.

In the first mode, the third coolant circuit 30 is switched to have no connection to the first coolant circuit 10, for the purposes of cooling the drive battery 31. Passing from the indirect condenser 53, the coolant is driven by the fourth pump 44 and, via the fifth control valve 55 which may be actuated to open up a passage from the second inlet 552 to the outlet 553, flows to the drive battery 31 and from there back to the indirect condenser 53. Thus, the third coolant circuit 30 is sealed from the first coolant circuit during the first mode.

In the intake tract 60, air flows via the electric compressor 21 and the charge-air cooler 22 to the internal combustion engine 11. Exhaust gas is discharged from the internal combustion engine 11 via the exhaust tract 70.

Turning now to FIG. 4, it shows a schematic diagram of the embodiment of FIG. 2 operating in an interior compartment mode (interchangeably referred to as a second mode) in which the internal combustion engine 11 is not in operation (e.g., not fueled), thermal energy is supplied to the interior compartment heating device 14 such that the interior compartment of the vehicle may be heated. During the second mode, in the first coolant circuit 10, the first control valve 51 is switched so as to open up a passage from the inlet 511 to the second outlet 513, such that coolant flows from the electric compressor 21, via the second pump 42, to the charge-air cooler 22. Here, at the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14, and from there via the second control valve 52, which may be actuated to open up a passage from the inlet 521 to the second outlet 523, and the fourth control valve 54, which may be actuated to open up a passage from the inlet 541 to the first outlet 542, back to the electric compressor 21. The flow is driven by the second pump 42.

In the second mode, the second coolant circuit 20 and the third coolant circuit 30 are not operated. The first, third and fourth pump 41, 43, and 44, respectively, are deactivated. In one example, flow originates from the first coolant circuit 10 during the second mode.

The bypass valve 61 is open to the bypass line 62, resulting in an air flow circuit from the electric compressor 21 via the charge-air cooler 22 and back to the electric compressor 21. As such, air is heated by the electric compressor and redirected thereto. The electric compressor 21 further heats coolant that is used to heat the cabin heater 14. When the cabin heater 14 is heated, a cabin heating fan may be activated when cabin heating is requested during the second mode.

Turning now to FIG. 5, it shows a schematic diagram of the embodiment of FIG. 2 operating in an interior compartment & battery mode (interchangeably referred to herein as a third mode) in which the internal combustion engine 11 is not in operation and thermal energy is supplied to the interior compartment heating device 14 and to the drive battery 31. As such, the interior compartment of the vehicle may be heated and the drive battery 31 may be heated in a starting mode, such that said drive battery reaches its operating temperature more quickly than without heating supplied during the third mode. During the third mode, in the first coolant circuit 10, the first control valve 51 is actuated to open up a passage from the inlet 511 to the second outlet 513, such that coolant flows from the electric compressor 21, via the activated second pump 42, to the charge-air cooler 22. Here, at the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14, and from there to the fourth control valve 54 via the second control valve 52, which may be actuated to open up a passage from the inlet 521 to the second outlet 523.

The fourth control valve 54 is actuated to open up a passage from the inlet 541 to the second outlet 543, such that coolant may flow from the first coolant circuit 10 into the third coolant circuit 30. The fifth control valve 55 is actuated to open up a passage from its first inlet 551 to the outlet 553, such that coolant flows from the first coolant circuit 10 to the battery 31. Downstream of the battery 31, the coolant flows via the seventh connection point 107 back to the first coolant circuit 10, which said coolant enters at the eighth connection point 108 downstream of the fourth control valve 54. From there, the coolant flows back to the electric compressor 21.

In the third mode, the second coolant circuit 20 is not operated. The first, third and fourth pump 41, 43, 44 are deactivated.

The bypass valve 61 is open to the bypass line 62, resulting in an air flow circuit from the electric compressor 21 via the charge-air cooler 22 and back to the electric compressor 21. As such, air is heated by the electric compressor and redirected thereto. The electric compressor 21 further heats coolant that is used to heat the cabin heater 14 and the battery 31. When the cabin heater 14 is heated, a cabin heating fan may be activated when cabin heating is requested. If cabin heating is not requested, then the cabin heating fan may be maintained deactivated to prevent a cabin temperature from increasing during the third mode.

Turning now to FIG. 6, it shows a schematic diagram of the embodiment of FIG. 2 operating in an interior compartment, battery, and heating of the internal combustion engine mode (interchangeably referred to herein as a fourth mode). In the fourth mode, the internal combustion engine 11 is not in operation, thermal energy is supplied to the interior compartment heating device 14 and to the drive battery 31, such that the interior compartment of the vehicle may be heated, the drive battery 31 may be heated in a starting mode, and the internal combustion engine 11 may be heated prior to a start of operation. In the first coolant circuit 10 while operating in the fourth mode, the first control valve 51 may be actuated to open up a passage from the inlet 511 to the second outlet 513, such that coolant flows from the electric compressor 21 via the activated second pump 42 to the charge-air cooler 22. At the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14. The second control valve 52 downstream of the interior compartment heating device 14 may be actuated to open up a passage from the inlet 521 both to the first outlet 522 and to the second outlet 523, such that coolant flows both to the internal combustion engine 11 and to the fourth control valve 54. From the internal combustion engine, the coolant flows via the fourth connection point 104 to the electric compressor; in the third control valve 53, both outlets 532 and 533 are closed.

The fourth control valve 54 may be actuated to open up a passage from the inlet 541 to the second outlet 543, such that coolant may flow from the first coolant circuit 10 into the third coolant circuit 30. The fifth control valve 55 may be actuated to open up a passage from its first inlet 551 to the outlet 553, such that coolant flows from the first coolant circuit 10 to the battery 31. Downstream of the battery 31, the coolant flows via the seventh connection point 107 back to the first coolant circuit 10, which said coolant enters at the eighth connection point 108 downstream of the fourth control valve 54. From there, the coolant flows back to the electric compressor 21.

In the fourth mode, the second coolant circuit 20 is not operated. The first, third and fourth pump 41, 43, 44 are deactivated.

The bypass valve 61 is open to the bypass line 62, resulting in an air flow circuit from the electric compressor 21 via the charge-air cooler 22 and back to the electric compressor 21. As such, the engine 11 is heated via only coolant heated by the electric compressor 21 during the fourth mode.

Turning now to FIG. 7, it shows a schematic diagram of the embodiment of FIG. 2 operating in an interior compartment, battery, and heating of the internal combustion engine, with air being supplied to the internal combustion engine mode (interchangeably referred to herein as a fifth mode. The internal combustion engine 11 is not in operation in the fifth mode and thermal energy is supplied to the interior compartment heating device 14 and to the drive battery 31, such that the interior compartment of the vehicle may be heated, the drive battery 31 may be heated in a starting mode, and the internal combustion engine 11 may be heated prior to a start of operation. In the first coolant circuit 10, the first control valve 51 may be actuated to open up a passage from the inlet 511 to the second outlet 513, such that coolant flows from the electric compressor 21 via the activated second pump 42 to the charge-air cooler 22. At the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14. The second control valve 52 downstream of the interior compartment heating device 14 may be actuated to open up a passage from the inlet 521 both to the first outlet 522 and to the second outlet 523, such that coolant flows both to the internal combustion engine 11 and to the fourth control valve 54. From the internal combustion engine 11, the coolant flows via the fourth connection point 104 to the electric compressor; in the third control valve 53, both outlets 532 and 533 are closed.

The fourth control valve 54 may be actuated to open up a passage from the inlet 541 to the second outlet 543, such that coolant may flow from the first coolant circuit 10 into the third coolant circuit 30. The fifth control valve 55 may be actuated to open up a passage from its first inlet 551 to the outlet 553, such that coolant flows from the first coolant circuit 10 to the battery 31. Downstream of the battery 31, the coolant flows via the seventh connection point 107 back to the first coolant circuit 10, which said coolant enters at the eighth connection point 108 downstream of the fourth control valve 54. From there, the coolant flows back to the electric compressor 21 via the ninth connection point 109.

In the fifth mode, the second coolant circuit 20 is not operated. The first, third and fourth pump 41, 43, 44 are deactivated.

The bypass valve 61 is open both to the bypass line 62 and to the internal combustion engine 11, such that, in addition to the air flow circuit from the electric compressor 21 via the charge-air cooler 22 and back to the electric compressor 21, an air flow is also provided to the internal combustion engine 11. As such, the engine 11 is heated via both air and coolant heated by the electric compressor 21 during the fifth mode.

Turning now to FIG. 8, it shows a schematic diagram of the embodiment of FIG. 2 operating in an interior compartment and heating of the internal combustion engine mode along with air flow to the engine (interchangeably referred to herein as a sixth mode). The internal combustion engine 11 is not in operation during the sixth mode, thermal energy is supplied to the interior compartment heating device 14 and to the internal combustion engine 11, such that the interior compartment of the vehicle may be heated and the internal combustion engine 11 may be heated prior to a start of operation. In the first coolant circuit 10 during the sixth mode, the first control valve 51 may be actuated to open up a passage from the inlet 511 to the second outlet 513, such that coolant flows from the electric compressor 21 via the activated second pump 42 to the charge-air cooler 22. At the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14. The second control valve 52 downstream of the interior compartment heating device 14 may be actuated to open up a passage from the inlet 521 to the first outlet 522, such that coolant is conducted to the internal combustion engine 11. From the internal combustion engine, the coolant flows via the fourth connection point 104 to the electric compressor; in the third control valve 53, both outlets 532 and 533 are closed.

In the sixth mode, the second coolant circuit 20 and the third coolant circuit 30 are not operated. The first, third and fourth pump 41, 43, 44 are deactivated.

The bypass valve 61 is open to the bypass line 62, resulting in an air flow circuit from the electric compressor 21 via the charge-air cooler 22 and back to the electric compressor 21. During the sixth mode, the electric compressor 21 heats air and coolant. The heated coolant is used to heat the cabin heater and the engine. However, since cabin heating is not requested during the sixth mode, the cabin heating fan is not activated and as a result, a vehicle cabin interior is not heated. The engine is heated via only heated coolant during the sixth mode. In one example, the heater air from the electric compressor 21 may not be used during the sixth mode due to the battery being unable to meet both driver demand and increase an operation of the electric compressor 21 to heat the engine 11 via heated air.

Turning now to FIG. 9, it shows a schematic diagram of the embodiment of FIG. 2 operating in an interior compartment and heating of the internal combustion engine” mode in which the internal combustion engine 11 is not in operation, thermal energy is supplied to the interior compartment heating device 14 and to the internal combustion engine 11, such that the interior compartment of the vehicle may be heated and the internal combustion engine 11 may be heated prior to a start of operation. Here, in the first coolant circuit 10, the first control valve 51 may be actuated to open up a passage from the inlet 511 to the second outlet 513, such that coolant flows from the electric compressor 21 via the activated second pump 42 to the charge-air cooler 22. Here, at the first connection point 101, the coolant flow merges with the flow path of the second coolant circuit 20, flows through the charge-air cooler 22, and exits the second coolant circuit 20 again at the second connection point 102. From there, the coolant flows to the interior compartment heating device 14. The second control valve 52 downstream of the interior compartment heating device 14 may be actuated to open up a passage from the inlet 521 to the first outlet 522, such that coolant is conducted to the internal combustion engine 11. From the internal combustion engine, the coolant flows via the fourth connection point 104 to the electric compressor; in the third control valve 53, both outlets 532 and 533 are closed.

In the seventh mode, the second coolant circuit 20 and the third coolant circuit 30 are not operated. The first, third and fourth pump 41, 43, 44 are deactivated.

The bypass valve 61 is open both to the bypass line 62 and to the internal combustion engine 11, such that, in addition to the air flow circuit from the electric compressor 21 via the charge-air cooler 22 and back to the electric compressor 21, an air flow is also provided to the internal combustion engine.

The illustrated modes may be set in a method according to the flow diagram in FIG. 10. In a first step 1002, the temperatures of the vehicle interior compartment, of the drive battery 31 and of the internal combustion engine 11 are determined. The temperatures may for example be measured by means of temperature sensors in said devices and transmitted to the control device 80, or may be determined in model-based fashion by the control device 80.

In a second step 1004, the requirements for heating said devices of the vehicle are determined via the control device 80, wherein it becomes desired for heated coolant to be directed to the devices if a threshold value of the temperature of a corresponding device is not reached.

In a third step 1006, a control command is transmitted from the control device 80 to the control valves and the pumps. In a fourth step 1008, the control valves and the pumps are switched such that a flow of coolant is directed to said devices in accordance with requirements.

Turning now to FIG. 11, it shows a method 1100 for selecting between the first through seventh modes based on a temperature of one or more of the vehicle cabin interior, the battery, and the engine. Instructions for carrying out method 1100 and the method of FIG. 10 may be executed by a controller (e.g., control device 80 of FIG. 2) based on instructions stored on a memory of the controller and in conjunction with signals received from sensors of the system, such as the sensors described above with reference to FIG. 2. The controller may employ actuators of the system to adjust operation, according to the method described below.

The method 1100 begins at 1102, which includes determining a vehicle cabin temperature. The vehicle cabin temperature may be determined based on feedback from a vehicle cabin temperature sensor. Additionally, or alternatively, the vehicle cabin temperature may be estimated based on a previous heating, an ambient temperature, a number of occupants, and other parameters.

At 1104, the method 1100 may include determining a battery temperature. The battery temperature may be determined based on feedback from a battery temperature sensor. Additionally, or alternatively, the battery temperature may be estimated based on a battery operation length, an ambient temperature, and a previous duration of heating the battery.

At 1106, the method 1100 may include determining an engine temperature. The engine temperature may be determined based on feedback from an engine temperature sensor. Additionally, or alternatively, the engine temperature may be estimated based on a previous engine run time, an ambient temperature, and a previous duration of heating the engine.

At 1108, the method 1100 may include determining if the engine is off. The engine may be off if the engine is not being fueled and combusting. If the engine is not off, then the heating operation may enter the first mode as shown in FIG. 3. In the first mode, coolant may remain in the high temperature circuit (e.g., the first circuit 10) without mixing with coolant in the second circuit and the third circuit. The coolant may flow from the engine and to the electric compressor, prior to flowing to a cabin heater if cabin heating is desired. In the first mode, the battery may not be heated. However, in some examples, if battery operation is anticipated and battery heating is desired based on a battery temperature being less than a threshold battery temperature, then a battery coolant circuit may be fluidly coupled to the high temperature circuit to heat the battery.

If the engine is off, then at 1110, the method 1100 may include determining if a vehicle cabin temperature is less than a threshold cabin temperature. The threshold cabin temperature may be based on a non-zero, positive number. In one example, the threshold cabin temperature is equal to a temperature set via a vehicle occupant. If the vehicle cabin temperature is less than the threshold cabin temperature, then heating of a vehicle cabin interior (e.g., an interior compartment) may be requested.

If vehicle cabin interior heating is requested, then the method 1100 may proceed to 1112, which includes determining if a battery temperature is less than a threshold battery temperature. In one example, the threshold battery temperature is based on a non-zero, positive number. The threshold battery temperature may be based on an operating temperature of the battery at which a desired efficiency is achieved.

If the battery temperature is less than the threshold battery temperature and battery heating is requested, then the method 1100 may proceed to 1114, which includes determining if the engine temperature is less than a threshold engine temperature. In one example, the threshold engine temperature is based on a non-zero, positive number. The threshold engine temperature may correspond to a desired engine operating temperature at which a desired efficiency is achieved. If the engine temperature is less than the threshold engine temperature and the method further includes anticipating an activation of the engine, then engine heating may be desired and the method 1100 may proceed to 1116, which includes entering the fourth and/or fifth heating mode.

The method may anticipate activation of the engine based on a battery state of charge (SOC), driver demand, and/or terrain. If the battery SOC is decreasing and is anticipated to no longer be able to meet driver demand, then the engine may be activated to supplement the battery output to meet driver demand. Additionally, or alternatively, if a terrain along which the vehicle is traveling becomes hilly or changes such that driver demand also increases, then the engine may be activated. By anticipating activation of the engine, the engine may be heated via the fourth/fifth modes to mitigate cold-start emissions.

The fourth and fifth modes may include where the high temperature circuit is closed from the high temperature radiator. The battery circuit is fluidly coupled to the high temperature circuit. The low temperature circuit is deactivated. Coolant from the cabin heater and the battery may be directed to the engine in each of the fourth and fifth modes. The fifth mode may be differentiated from the fourth mode in that warm air from the electric compressor may be directed to the engine to increase a warm-up speed thereof. The fifth mode may be selected instead of the fourth mode based on the battery SOC and the battery temperature. For example, if the battery temperature increases to a temperature greater than the threshold battery temperature during the fourth mode and/or the battery SOC is greater than a threshold battery SOC and/or a driver demand will still be met following activation of the electric compressor, then the fifth mode may be activated and the electric compressor may be activated to flow warm air to the engine. The intercooler may not cool air from the electric compressor since the pump of the low temperature circuit is deactivated and coolant is not directed to the intercooler. The threshold battery SOC may be based on a non-zero, positive number.

Returning to 1114, if the engine temperature is not less than the threshold engine temperature and/or if the engine is not anticipated to be turned on, then the method 1100 may proceed to 1118, which includes entering a third mode. The third mode may include heating only the cabin and/or the battery. In the third mode, the battery circuit is fluidly coupled to the high temperature circuit. The low temperature circuit is deactivated and the pump therein is not on. The air bypass valve is positioned such that air from the electric compressor does not flow to the engine. Coolant in the high temperature circuit does not flow to the engine or to the high temperature radiator during the third mode.

Returning to 1112, if the battery temperature is not less than the threshold battery temperature and battery heating is not requested, then the method 1100 may proceed to 1120, which includes entering the second mode and heating only the vehicle cabin interior. During the second mode, the battery circuit may be off and sealed from the high temperature circuit. The low temperature circuit may be sealed from the high temperature circuit and the pump therein may be off. Warm air from the electric compressor may heat coolant flowing through the intercooler of the high temperature circuit to provide warm coolant to the cabin heater. A cabin heating fan may be activated to blow warm air from the cabin heater to the vehicle cabin.

Returning to 1110, if the vehicle cabin temperature is not less than the threshold cabin temperature, then vehicle cabin heating may not be requested and the method 1100 proceeds to 1122, which include determining if the battery temperature is less than the threshold battery temperature, similar to 1112 described above. If the battery temperature is less than the threshold battery temperature, then the method 1100 may proceed to enter the third mode at 1118. In this example, the third mode may heat coolant via the electric compressor and flow the heated coolant to the cabin heater and the battery. The cabin heating fan may be deactivated to mitigate the vehicle cabin temperature from increasing. In this way, only the battery may be heated during the third mode while heated coolant flows to each of the cabin heater and the battery circuit.

If the battery temperature is not less than the threshold battery temperature, then the method 1100 proceeds to 1124 to determine if the engine temperature is less than the threshold engine temperature, similar to 1114. If the engine temperature is less than the threshold engine temperature, then only engine heating is requested and the method 1100 proceeds to 1126, which includes entering a sixth mode or a seventh mode. Each of the sixth mode and the seventh mode includes heating the engine via coolant heated by the electric compressor. In both modes, the engine is off and anticipated to be turned on. The seventh mode may be differentiated from the sixth mode in that warm air from the electric compressor is directed to the engine. Heating the engine with warm air from the electric compressor may increase a rate of temperature increase of the engine. Additionally, battery power consumption may increase when using air from the electric compressor to heat the engine. Thus, to heat the engine via warm air from the electric compressor, the battery SOC may be compared to the threshold SOC to determine if the battery can meet a driver demand and increase operating output of the electric compressor.

If the engine temperature is not less than the threshold engine temperature, then engine heating is not requested and the method 1100 may proceed to 1128, which includes not entering a heating mode. As such, the electric compressor may not be activated to heat coolant for any of the cabin heater, the battery, and the engine. The pumps of each of the high temperature circuit, the low temperature circuit, and the battery may be deactivated.

FIGS. 2-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

In this way, a hybrid vehicle including a battery for powering an electric motor and an internal combustion engine configured to combust fuel or other non-electric fuel source may utilize an electric compressor as a heating device during a plurality of conditions. The electric compressor may be activated when heating is requested by the battery, the vehicle cabin interior, and/or the engine while the engine is off. The electric heater may heat one or more devices via heating coolant and/or air. By doing this, emissions of the hybrid vehicle may be reduced.

The disclosure also provides support for a thermal management system for a vehicle comprising an internal combustion engine comprising an intake tract and an exhaust tract, the vehicle further comprising at least one electric motor driven by a battery, the thermal management system comprising: a first coolant circuit coupled to each of the internal combustion engine, an electric compressor, an electrical charge-air compressor arranged in the intake tract, an interior compartment heating device, and a high-temperature radiator, a second coolant circuit coupled to each of a charge-air cooler arranged in the intake tract and a low-temperature radiator, a third coolant circuit coupled to each of the battery and at least one indirect condenser, a controller with instructions stored in non-transitory memory thereof that when executed cause the controller to: adjust a position of pumps and valves arranged in the first coolant circuit, the second coolant circuit, and the third coolant circuit to direct a flow of coolant heated by an electric compressor to one or more of the internal combustion engine, the interior compartment heating device, and the battery when the engine is off. In a first example of the system, a bypass valve is arranged in the intake tract downstream of the charge-air cooler relative to a direction of coolant flow, and wherein a bypass line branches off from the bypass valve and fluid couples to the intake tract at a junction upstream of the electric compressor. In a second example of the system, optionally including the first example, the system further comprises: a first control valve is arranged in the first coolant circuit downstream of the electrical compressor in a location between the electrical compressor and the interior compartment heating device. In a third example of the system, optionally including one or both of the first and second examples, the system further comprises: a second control valve is arranged in the first coolant circuit downstream of the interior compartment heating device in a location between the interior compartment heating device and the internal combustion engine. In a fourth example of the system, optionally including one or more or each of the first through third examples, the system further comprises: a third control valve is arranged in the first coolant circuit downstream of the internal combustion engine in a location between the internal combustion engine and the high-temperature cooling device. In a fifth example of the system, optionally including one or more or each of the first through fourth examples, the system further comprises: a fourth control valve is coupled to the first coolant circuit and the third coolant circuit, the fourth control valve is arranged downstream of the second control valve in a location between the second control valve and the electrical compressor. In a sixth example of the system, optionally including one or more or each of the first through fifth examples, the system further comprises: a fifth control valve arranged in the third coolant circuit upstream of the battery in a location between the fourth control valve and the battery.

The disclosure also provides support for a vehicle system, comprising: an internal combustion engine comprising an intake tract and an exhaust tract, at least one electric motor driven by a battery, a bypass valve is arranged in the intake tract downstream of the charge-air cooler relative to a direction of coolant flow, and wherein a bypass line branches off from the bypass valve and fluid couples to the intake tract at a junction upstream of the electric compressor a first coolant circuit coupled to each of the internal combustion engine, an electric compressor, an electrical charge-air compressor arranged in the intake tract, an interior compartment heating device, and a high-temperature radiator, a second coolant circuit coupled to each of a charge-air cooler arranged in the intake tract and a low-temperature radiator, a third coolant circuit coupled to each of the battery and at least one indirect condenser, a first control valve is arranged in the first coolant circuit downstream of the electrical compressor in a location between the electrical compressor and the interior compartment heating device, a second control valve is arranged in the first coolant circuit downstream of the interior compartment heating device in a location between the interior compartment heating device and the internal combustion engine, a third control valve is arranged in the first coolant circuit downstream of the internal combustion engine in a location between the internal combustion engine and the high-temperature cooling device, a fourth control valve is coupled to the first coolant circuit and the third coolant circuit, the fourth control valve is arranged downstream of the second control valve in a location between the second control valve and the electrical compressor, and a fifth control valve arranged in the third coolant circuit upstream of the battery in a location between the fourth control valve and the battery. In a first example of the system, the system further comprises: a controller with instructions stored in non-transitory memory thereof that when executed cause the controller to heat coolant in the first circuit via at least the internal combustion engine when the internal combustion engine is on during a first mode. In a second example of the system, optionally including the first example, the instructions further cause the controller to heat coolant in the first circuit via the electric compressor when the internal combustion engine is off during a second mode, wherein the second mode comprises flowing heated coolant to the interior compartment heating device. In a third example of the system, optionally including one or both of the first and second examples, the instructions further cause the controller to heat coolant in the first circuit via the electric compressor when the internal combustion engine is off during a third mode, wherein the third mode comprises flowing heated coolant to the interior compartment heating device and the battery. In a fourth example of the system, optionally including one or more or each of the first through third examples, the instructions further cause the controller to heat coolant in the first circuit via the electric compressor when the internal combustion engine is off during a fourth mode, wherein the fourth mode comprises flowing heated coolant to the interior compartment heating device, the battery, and the internal combustion engine. In a fifth example of the system, optionally including one or more or each of the first through fourth examples, the instructions further cause the controller to heat coolant in the first circuit via the electric compressor when the internal combustion engine is off during a fifth mode, wherein the fifth mode comprises flowing heated coolant to the interior compartment heating device, the battery, and the internal combustion engine, and wherein the fifth mode further comprises heating the internal combustion engine via air from the electric compressor. In a sixth example of the system, optionally including one or more or each of the first through fifth examples, the instructions further cause the controller to heat coolant in the first circuit via the electric compressor when the internal combustion engine is off during a sixth mode, wherein the sixth mode comprises flowing heated coolant to the internal combustion engine. In a seventh example of the system, optionally including one or more or each of the first through sixth examples, the instructions further cause the controller to heat coolant in the first circuit via the electric compressor when the internal combustion engine is off during a seventh mode, wherein the sixth mode comprises flowing heated coolant to the internal combustion engine, and wherein the seventh mode further comprises heating the internal combustion engine via air from the electric compressor.

The disclosure also provides support for a method for a thermal management system for a vehicle comprising an internal combustion engine comprising an intake tract and an exhaust tract, the vehicle further comprising at least one electric motor driven by a battery, the thermal management system further comprising a first coolant circuit coupled to each of the internal combustion engine, an electric compressor, an electrical charge-air compressor arranged in the intake tract, an interior compartment heating device, and a high-temperature radiator, a second coolant circuit coupled to each of a charge-air cooler arranged in the intake tract and a low-temperature radiator, and a third coolant circuit coupled to each of the battery and at least one indirect condenser, the method comprising: heating coolant with only the electric compressor when the internal combustion engine is off, and flowing the coolant to one or more of the battery, the internal combustion engine, and the interior compartment heating device. In a first example of the method, the method further comprises: flowing heated air from the electric compressor to the internal combustion engine with the coolant. In a second example of the method, optionally including the first example, the heated air is also redirected back to the electric supercharger. In a third example of the method, optionally including one or both of the first and second examples, the method further comprises: heating the coolant with the internal combustion engine when the internal combustion engine is on. In a fourth example of the method, optionally including one or more or each of the first through third examples, air exiting the electric compressor is returned to the electric compressor and bypasses the internal combustion engine when the internal combustion engine does not request heating.

Note that the example control and estimation routines included herein may be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology may be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A thermal management system for a vehicle comprising an internal combustion engine comprising an intake tract and an exhaust tract, the vehicle further comprising at least one electric motor driven by a battery, the thermal management system comprising:
a first coolant circuit coupled to each of the internal combustion engine, an electric compressor, an electric charge-air compressor arranged in the intake tract, an interior compartment heating device, and a high-temperature radiator;
a second coolant circuit coupled to each of a charge-air cooler arranged in the intake tract and a low-temperature radiator;
a third coolant circuit coupled to each of the battery and at least one indirect condenser;
a controller with instructions stored in non-transitory memory thereof that when executed cause the controller to:
adjust a position of pumps and valves arranged in the first coolant circuit, the second coolant circuit, and the third coolant circuit to direct a flow of coolant heated by the electric compressor to one or more of the internal combustion engine, the interior compartment heating device, and the battery when the internal combustion engine is off.

2. The thermal management system of claim 1, wherein a bypass valve is arranged in the intake tract downstream of the charge-air cooler relative to a direction of coolant flow, and wherein a bypass line branches off from the bypass valve and fluid couples to the intake tract at a junction upstream of the electric compressor.

3. The thermal management system of claim 1, further comprising a first control valve is arranged in the first coolant circuit downstream of the electric compressor in a location between the electric compressor and the interior compartment heating device.

4. The thermal management system of claim 3, further comprising a second control valve is arranged in the first coolant circuit downstream of the interior compartment heating device in a location between the interior compartment heating device and the internal combustion engine.

5. The thermal management system of claim 4, further comprising a third control valve is arranged in the first coolant circuit downstream of the internal combustion engine in a location between the internal combustion engine and the high-temperature radiator.

6. The thermal management system of claim 5, further comprising a fourth control valve is coupled to the first coolant circuit and the third coolant circuit, the fourth control valve is arranged downstream of the second control valve in a location between the second control valve and the electric compressor.

7. The thermal management system of claim 6, further comprising a fifth control valve arranged in the third coolant circuit upstream of the battery in a location between the fourth control valve and the battery.

8. A vehicle system, comprising:
an internal combustion engine comprising an intake tract and an exhaust tract;
at least one electric motor driven by a battery;
a bypass valve is arranged in the intake tract downstream of a charge-air cooler relative to a direction of coolant flow, and wherein a bypass line branches off from the bypass valve and fluid couples to the intake tract at a junction upstream of an electric compressor
a first coolant circuit coupled to each of the internal combustion engine, the electric compressor, the electric charge-air compressor arranged in the intake tract, an interior compartment heating device, and a high-temperature radiator;
a second coolant circuit coupled to each of a charge-air cooler arranged in the intake tract and a low-temperature radiator;
a third coolant circuit coupled to each of the battery and at least one indirect condenser;
a first control valve is arranged in the first coolant circuit downstream of the electric compressor in a location between the electric compressor and the interior compartment heating device;
a second control valve is arranged in the first coolant circuit downstream of the interior compartment heating device in a location between the interior compartment heating device and the internal combustion engine;
a third control valve is arranged in the first coolant circuit downstream of the internal combustion engine in a location between the internal combustion engine and the high-temperature radiator;
a fourth control valve is coupled to the first coolant circuit and the third coolant circuit, the fourth control valve is arranged downstream of the second control valve in a location between the second control valve and the electric compressor; and
a fifth control valve arranged in the third coolant circuit upstream of the battery in a location between the fourth control valve and the battery.

9. The vehicle system of claim 8, further comprising a controller with instructions stored in non-transitory memory thereof that when executed cause the controller to heat coolant in the first circuit via at least the internal combustion engine when the internal combustion engine is on during a first mode.

10. The vehicle system of claim 9, wherein the instructions further cause the controller to heat coolant in the first coolant circuit via the electric compressor when the internal combustion engine is off during a second mode, wherein the second mode comprises flowing heated coolant to the interior compartment heating device.

11. The vehicle system of claim 9, wherein the instructions further cause the controller to heat coolant in the first coolant circuit via the electric compressor when the internal combustion engine is off during a third mode, wherein the third mode comprises flowing heated coolant to the interior compartment heating device and the battery.

12. The vehicle system of claim 9, wherein the instructions further cause the controller to heat coolant in the first coolant circuit via the electric compressor when the internal combustion engine is off during a fourth mode, wherein the fourth mode comprises flowing heated coolant to the interior compartment heating device, the battery, and the internal combustion engine.

13. The vehicle system of claim 9, wherein the instructions further cause the controller to heat coolant in the first coolant circuit via the electric compressor when the internal combustion engine is off during a fifth mode, wherein the fifth mode comprises flowing heated coolant to the interior compartment heating device, the battery, and the internal combustion engine, and wherein the fifth mode further comprises heating the internal combustion engine via air from the electric compressor.

14. The vehicle system of claim 9, wherein the instructions further cause the controller to heat coolant in the first coolant circuit via the electric compressor when the internal combustion engine is off during a sixth mode, wherein the sixth mode comprises flowing heated coolant to the internal combustion engine.

15. The vehicle system of claim 9, wherein the instructions further cause the controller to heat coolant in the first coolant circuit via the electric compressor when the internal combustion engine is off during a seventh mode, wherein the seventh mode comprises flowing heated coolant to the internal combustion engine, and wherein the seventh mode further comprises heating the internal combustion engine via air from the electric compressor.

16. A method for a thermal management system for a vehicle comprising an internal combustion engine comprising an intake tract and an exhaust tract, the vehicle further comprising at least one electric motor driven by a battery, the thermal management system further comprising a first coolant circuit coupled to each of the internal combustion engine, an electric compressor, an electric charge-air compressor arranged in the intake tract, an interior compartment heating device, and a high-temperature radiator, a second coolant circuit coupled to each of a charge-air cooler arranged in the intake tract and a low-temperature radiator, and a third coolant circuit coupled to each of the battery and at least one indirect condenser; the method comprising:
heating coolant with only the electric compressor when the internal combustion engine is off; and
flowing the coolant to one or more of the battery, the internal combustion engine, and the interior compartment heating device.

17. The method of claim 16, further comprising flowing heated air from the electric compressor to the internal combustion engine with the coolant.

18. The method of claim 17, wherein the heated air is also redirected back to the electric compressor.

19. The method of claim 16, further comprising heating the coolant with the internal combustion engine when the internal combustion engine is on.

20. The method of claim 16, wherein air exiting the electric compressor is returned to the electric compressor and bypasses the internal combustion engine when the internal combustion engine does not request heating.
